(19) United States
(12) Patent Application Publication
(10) Pub. No.: US 2014/0061380 A1
(43) Pub. Date: Mar. 6, 2014

(54) MODULARIZED AIRPLANE STRUCTURES AND METHODS

(71) Applicant: Jie Zhao, Midlothian, VA (US)

(72) Inventor: Jie Zhao, Midlothian, VA (US)

(21) Appl. No.: 13/602,601

(22) Filed: Sep. 4, 2012

(51) Int. Cl. B64C 13/28

(52) U.S. Cl. 244/99.3

(57) ABSTRACT

A modularized airplane includes two separably interconnected modules. A first module, incorporating substantial airplane styles, includes a fuselage portion and at least one wing or stabilizer with an associated control surface. A second module carries a set of essential flight components sufficing airplane operations, including propulsion unit, servo for moving control surface, and power source. Magnetic connectors affixed on the modules facilitate inter-modular structural connection. A control linkage assembly, linking control surface on first module and associated servo on second module, is formed with two portions longitudinally movable and separably connected by two magnetic connectors oppositely affixed on each portion. The structural connection and the servo-to-control surface linkage assembly facilitate substantially effortless inter-modular connections to form a functional airplane, as well as nondestructive inter-modular disconnection. The second module can be connected to different aerodynamic styled first modules to form airplanes for different applications, using same essential components.

### CROSS-REFERENCE TO RELATED APPLICATIONS

This application claims the benefit of U.S. patent application Ser. No. 12/074,737, filed Mar. 6, 2008 by the present inventor.

### BACKGROUND

1. Field of Invention

The present invention relates generally to modularized airplanes. More specifically, it relates to remotely controlled and/or autonomously controlled modularized airplane structures and methods which enable rapid and substantially effortless inter-modular connection to form modularized airplanes, enable differing airplanes to be formed using the same set of essential airplane components, and allow nondestructive module-wise disconnection to protect the airplane modules and the components from damage in high impact events.

2. Description of Prior Art

The technology advancement in microelectronics, propulsion components, powerful lightweight batteries and new materials have enabled unmanned airplanes to be built ever lighter and smaller. Remotely controlled and/or autonomously controlled airplanes of a few grams in weight and a few inches in wingspan have already become reality. Airplanes of such scale have a range of applications from sport recreation to scientific and military applications that conventional larger airplanes are unable to carry out. For an owner of such airplanes it is often desirable to have multiple airplanes of differing specifications to meet various application requirements.

Conventionally airplanes in general have been designed and constructed as integral units with fixedly-mounted components and inseparable control linkages, and each has its own designated body and essential components. For remotely controlled and/or autonomously controlled airplanes the main disadvantage of the conventional construction is that it is costly to own multiple airplanes for applications of various natures due to the lack of mechanisms for conveniently sharing expensive components and structures among airplanes. Another disadvantage is its relatively high susceptibility to damages during high impact events due to its inseparable integral structure and interconnections. Yet another drawback of the conventional integral airplane construction is that it makes maintenance and repair more laborious.

Therefore, it would be advantageous for remotely controlled and/or autonomously controlled airplanes to be modularized into a component module collectively carrying essential airplane components and another style-specific module incorporating substantial airplane style characteristics and aerodynamic specifications, wherein the module members are arranged to operatively and separably interconnect to one another to form a functional airplane. The component module is relatively more expensive than the style-specific module because of the essential airplane components therein, and it can be selectively integrated with differing style-specific modules to form differing airplanes, thus enabling the sharing of essential airplane components among multiple airplanes.

For airplanes that weigh a few grams the handling of the small and delicate structures and components poses challenges to untrained hands. Therefore modularized airplanes of small scale would be more practical if substantially effortless and automatic means were provided for inter-modular structural and functional connection and disconnection without involving extensive physical handling.

There have been attempts to modularize airplane structure. A simple and popular method is to render the main lifting wings structurally separate from, yet attachable to, the rest of the airplane body to form a functional airplane. This modular wing method is typically used for convenient airplane transportation and storage, and is unable to offer substantial airplane variation. U.S. Pat. No. 5,046,979 to Ragan et al. disclosed a chassis module for remotely controlled airplanes to collectively mount essential components, which can be removably mounted inside the fuselages of differing airplane. However the invention lacks means for non-strenuously transferring the module from airplane to airplane, and it also lacks means for substantially effortlessly linking and de-linking the airplane control linkages. U.S. Pat. No. 6,126,113 to Navickas revealed a method for modularizing helicopters, which provides the mechanism to mix differing helicopter modules into helicopters. However the processes for disintegrating and reintegrating a modular helicopter are still complex and laborious.

In view of the prior art at the time the present invention was made, while many took the advantages that the modularization concept offers, such as component sharing and maintenance accessibility, it was not obvious to those of ordinary skill in the pertinent art that a modularized airplane with connection means capable of substantially automatic and effortless inter-modular integration and disintegration is desirable, nor was it obvious how such a modularized airplane could be provided.

### SUMMARY OF THE INVENTION

The general purpose of the present invention, which will be described subsequently in greater detail, is to provide a new modularized remotely controlled and/or autonomously controlled airplane construction that enables effortless and substantially automatic inter-modular integration and nondestructive disintegration. Such modularized airplanes allow for swift, routine and effortless module mixing to form differing airplanes, sharing essential airplane components among differing airplanes, and improving crash damage resistance, which makes modularized airplanes, especially small modularized airplanes, highly practical and reduces the cost of owning multiple airplanes.

To attain this, the present invention generally comprises:

a style-specific airplane module having a fuselage portion, wings and stabilizers with control surfaces and incorporating substantial airplane style characteristics and aerodynamic specifications;

a shared component airplane module carrying essential airplane components including power supply units, propulsion units, control actuating devices, control-commands providing electronics units, interconnected operatively;

structural connection means facilitating substantially effortless inter-modular structural connection and excessive structural tension induced nondestructive inter-modular disconnection, such as, but not limited to, magnetic-attraction operated connection interfaces and alignment structures;

control linkage means having a control linkage assembly formed by two linkage portions separably connected by magnetic attraction means that facilitates substantially automatic forming of control motion transmission linkage for control motion transmission including from a control actuating device to a control surface, as well as excessive-tension induced nondestructive linkage disconnection.

Upon being brought to physical proximity within the magnetic attraction range of the structural connecting means, the airplane style-specific module and the shared-component module will structurally connect to one another by the structural connection means substantially automatically, which in turn will result in the two control linkage portions of the linkage assembly being brought to within the magnetic connecting force range, and control link connection will subsequently take place by the control linkage means substantially automatically, thus forming a structurally and functionally complete modular airplane, which allows modular disconnection and control transmission de-linking in excessive structural and transmission linkage tension situations, thus preventing airplane module and component damage, and facilitating routine substantial effortless methods for disassembling airplane.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide modularized airplane structures and methods that facilitate routine, rapid and substantially automatic inter-modular connection and disconnection to maximize efficiency and practicality for forming and unforming modularized airplanes, especially light-weight unmanned modularized airplanes.

Another object of the present invention is to provide inter-modular connection means for modularized airplanes to allow nondestructive inter-modular disconnection in situations of excessive structural stress and control linkage tension, such as airplane crash, to minimize possible structural and component damages.

Another object of the present invention is to provide a modularized airplane design enabling routine sharing of common and essential airplane components among differing airplanes to reduce costs of owning and maintaining multiple airplanes.

Another object of the present invention is to provide a modularized airplane design that allows substantial airplane style characteristics and aerodynamic specifications to be incorporated into interchangeable modules which can routinely and effortlessly integrate to a commonly shared module of essential airplane components to form airplanes for various applications.

Yet another object of the present invention is to provide a modularized airplane construction that facilitates greater structural and component accessibility for maintenance and repair.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is an exploded perspective view of a modularized airplane embodying the current invention.

FIG. 2 is a perspective view of a modularized airplane shown in FIG. 1 with module members fully connected.

FIG. 3 is a simplified close-up perspective view of an embodiment of the inter-modular structural connection means of the current invention employed in the airplane shown in FIG. 1 and FIG. 2.

FIG. 4A is a perspective view of an embodiment of the control linkage means of the current invention employed in the airplane shown in FIG. 1 and FIG. 2. The components in this view are for illustrating the principle only and not physically identical with the components in FIG. 1 and FIG. 2

FIG. 4B-4G are perspective views of additional embodiments of the control linkage means of the current invention, for illustrating principles and not to scale.

FIG. 4H is a perspective view of additional embodiment of the control linkage means of the current invention utilizing the linkage axial rotation about its longitudinal axis for control motion transmission, for illustrating principles and not to scale.

FIG. 4I is a perspective view of additional embodiment of the control linkage means of the current invention utilizing both linear longitudinal linkage motion and linkage axial rotation about its longitudinal axis for the transmission of two independent control motions, for illustrating principles and not to scale.

FIG. 4J is a perspective close-up view of a axial rotation engagement device embodiment of the control linkage means utilizing the linkage axial rotation about its longitudinal axis for control motion transmission, for illustrating principles and not to scale.

FIG. 5A is a simplified two-dimensional side view of an embodiment of the stress isolation means of the current invention as employed in the airplane shown in FIG. 1 and FIG. 2. The components in this view is for illustrating the principle only and not physically identical with the components in FIG. 1 and FIG. 2

FIG. 5B-5D are simplified two-dimensional side views of additional embodiments of the stress isolation means of the current invention.

FIG. 6 is an exploded perspective view of a modularized airplane embodying the current invention employing alternative embodiments of the inter-modular structural connection means and control linkage means from that shown in FIG. 4G and FIG. 4C.

FIG. 7 is an illustrative view of a differing modularized airplane formed by the same component module in FIG. 6 interconnected with a differing character module.

FIG. 8 is a symbolic schematic diagram of operatively interconnected airplane essential components.

FIG. 9A is an exploded perspective view of a modularized airplane embodying the current invention employing alternative embodiment with component module positioned substantially inside fuselage space of character module.

FIG. 9B is an exploded perspective view of a modularized airplane embodying the current invention employing frame structure in character module integrated with inter-modular structural connectors, fuselage connecters and control linkage guides.

FIG. 9C is an exploded perspective view of a modularized airplane embodying the current invention employing alternative embodiments of component module having more than one sub-modules.

FIG. 10A is a perspective view of a portion of character module of a modularized airplane having a control surface movably attached to a fin fixedly joined to the fuselage.

FIG. 10B is a perspective view of a portion of character module of a modularized airplane having a standalone control surface unassociated with any fin, and movably mounted to the fuselage.

### DETAILED DESCRIPTION OF THE PREFERRED EMBODIMENTS

Turning now descriptively to the drawings, in which similar reference characters denote similar elements throughout the several views.

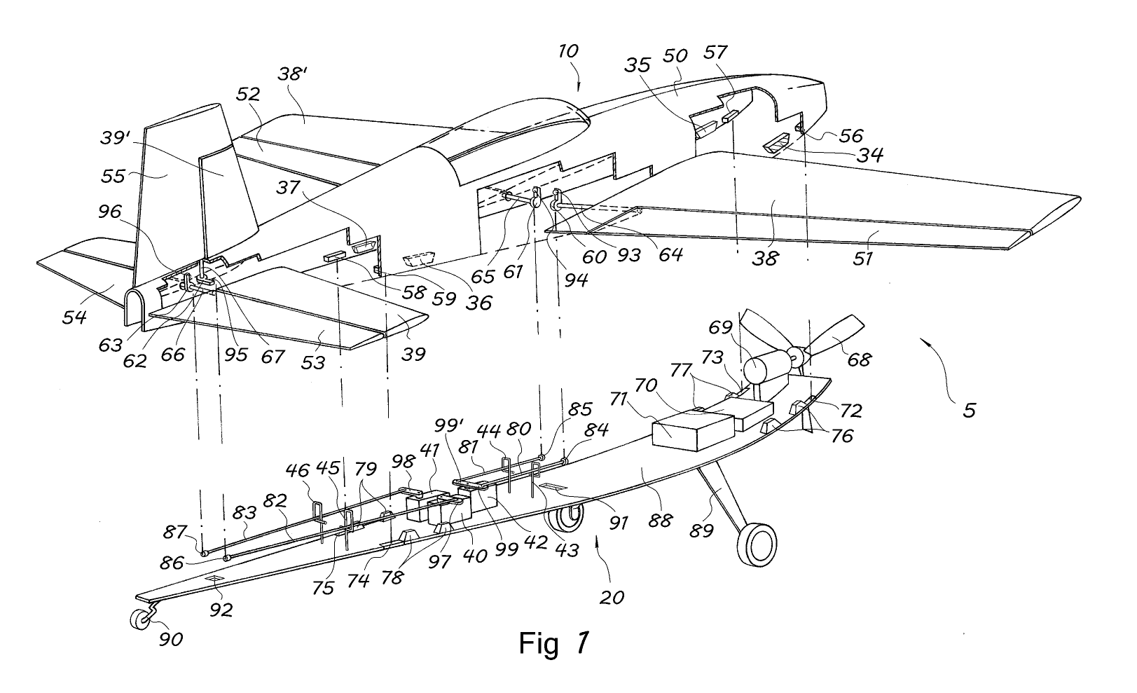

Referring to the drawings, and in particular to FIGS. 1 to 3, FIG. 4A, FIG. 5A, FIG. 8, FIG. 10A, FIG. 10B a modularized airplane according to the present invention is referenced generally by reference numeral 5 in the preferred embodiment. The modularized airplane 5 comprises an airplane style- characteristics-specific module (“character module” hereinafter), denoted 10 in FIG. 1, and a shared component module (“component module” hereinafter), denoted 20 in FIG. 1.

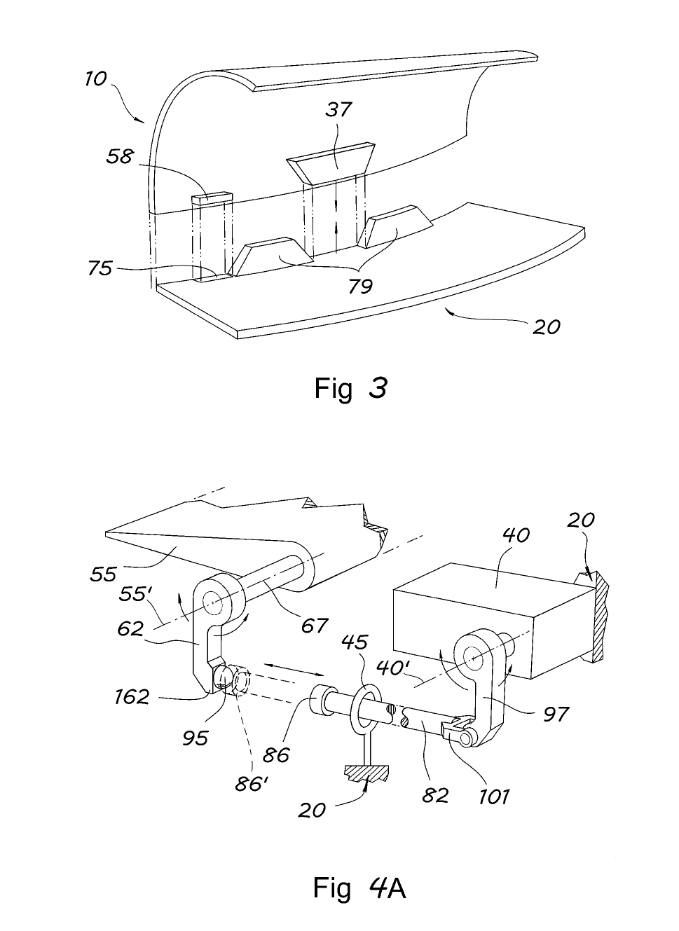

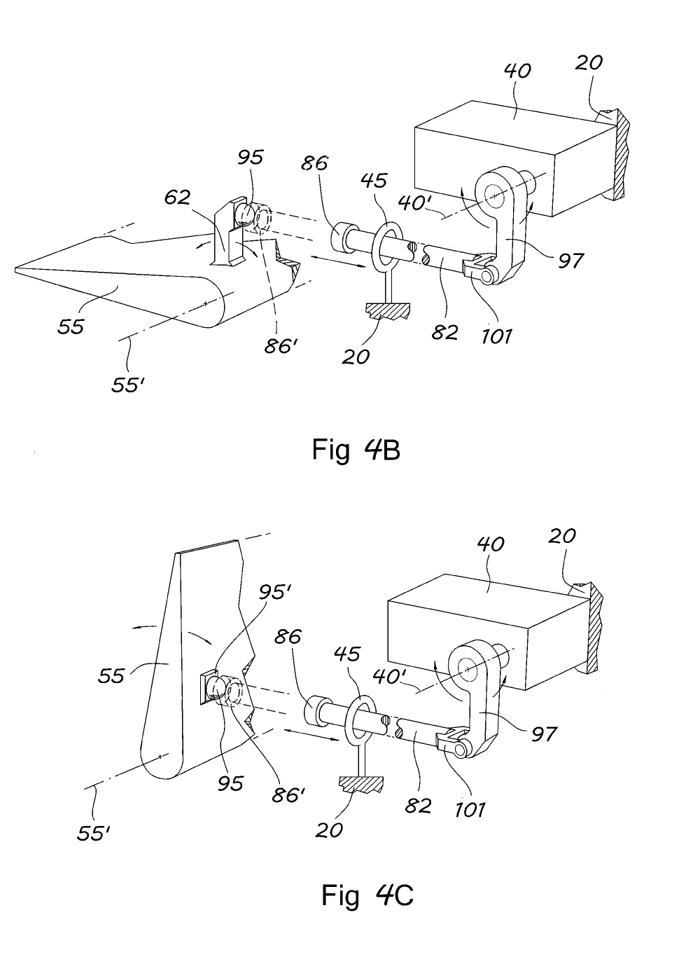

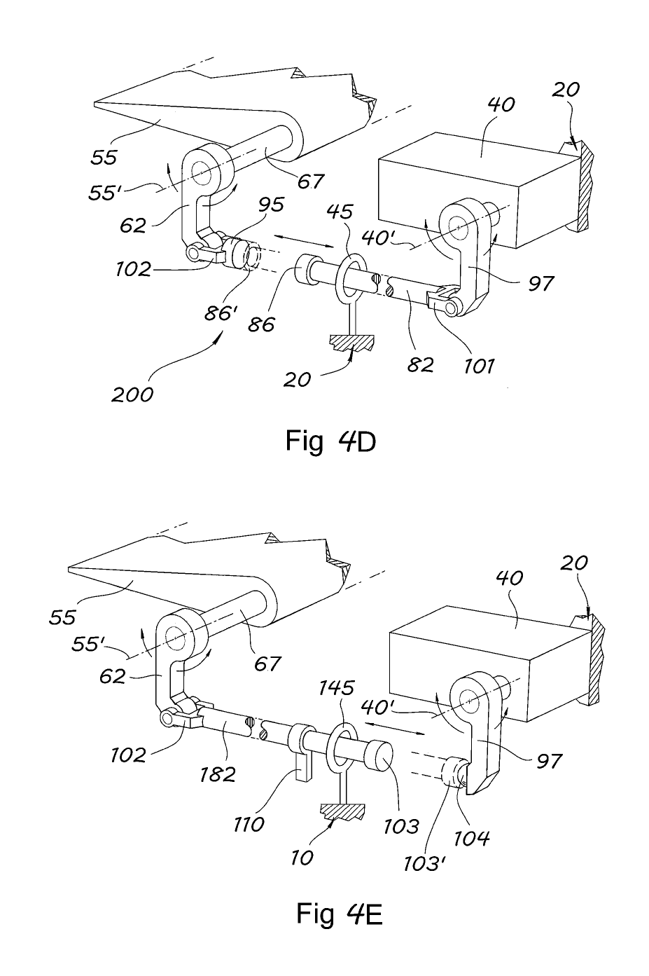

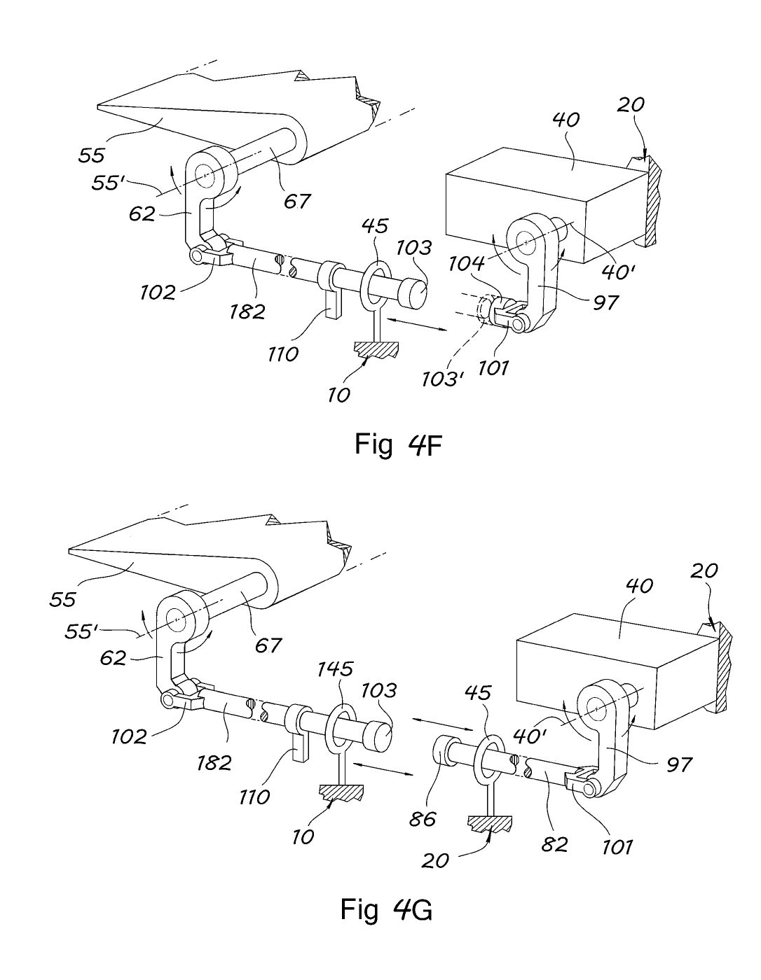

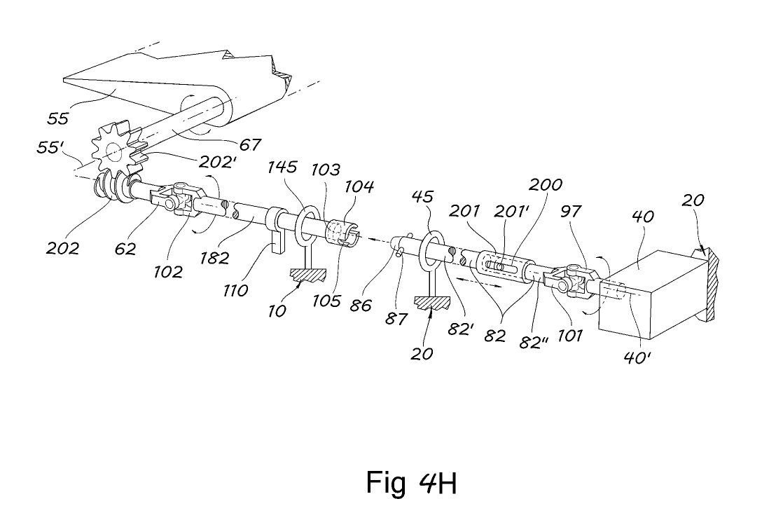

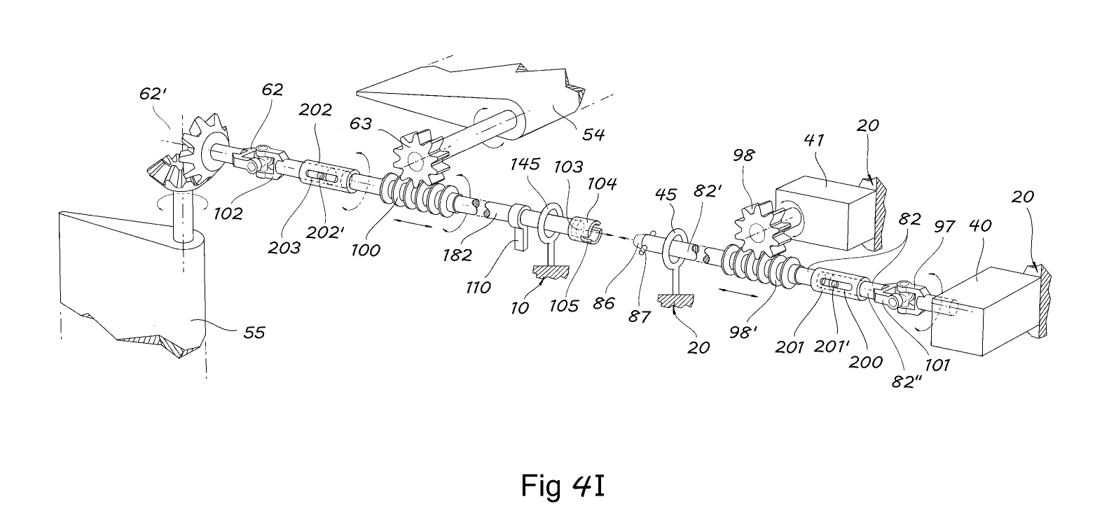

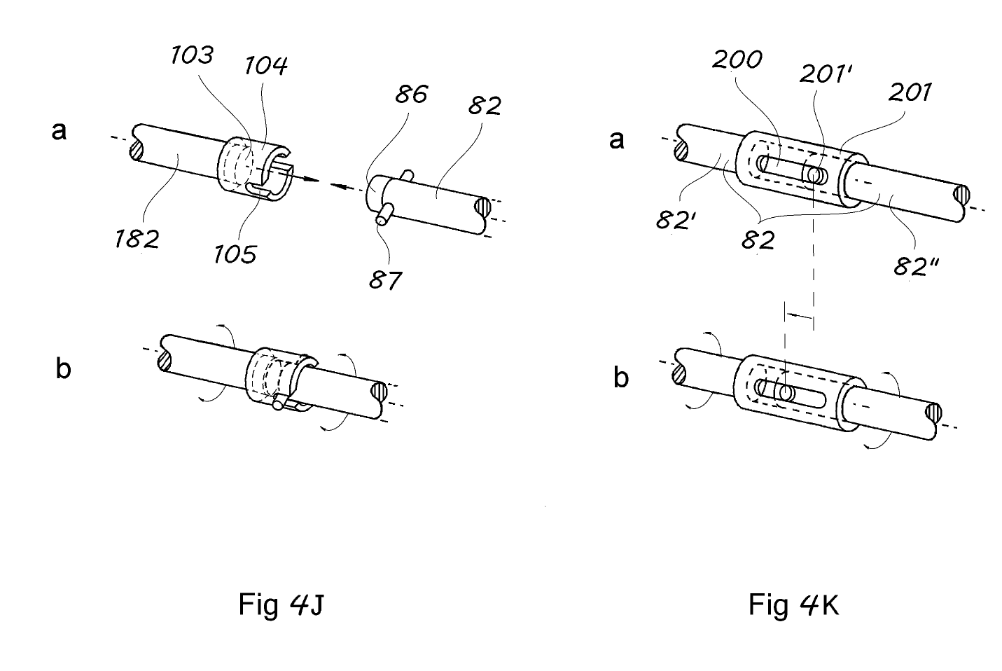

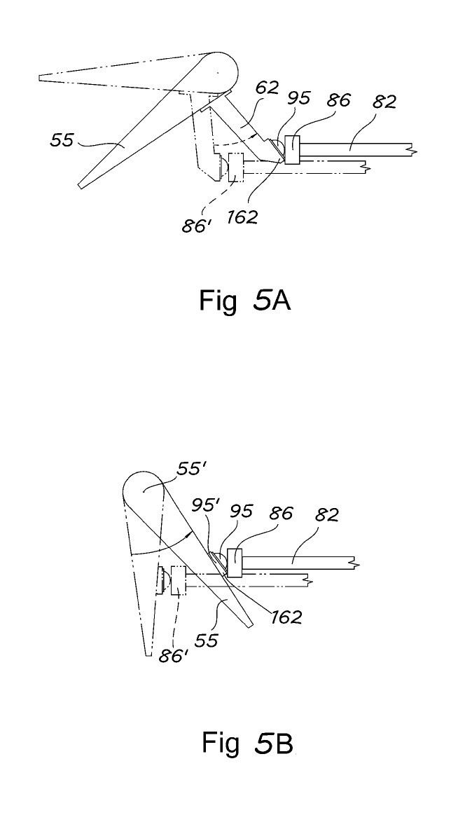

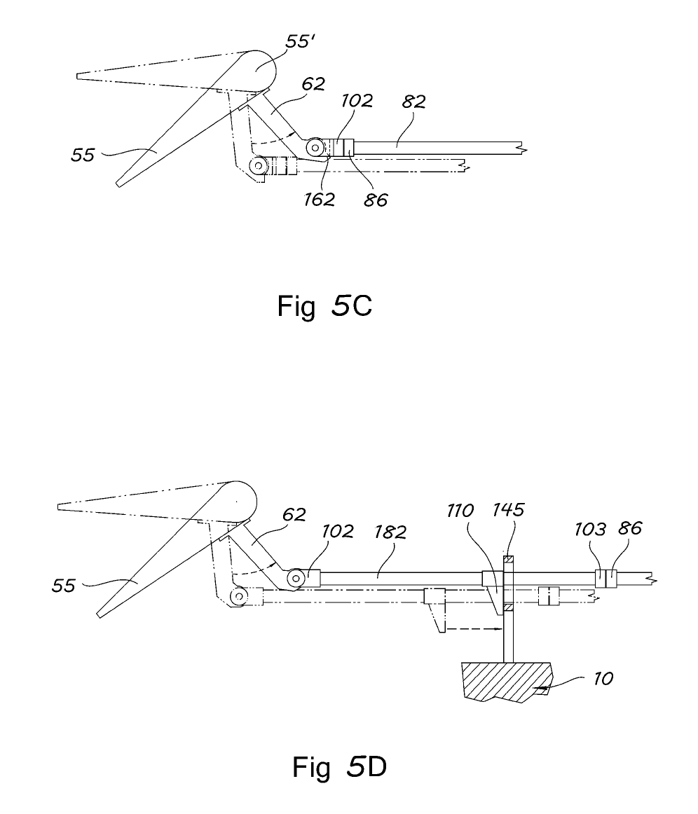

Character module 10 comprises a fuselage portion 50, airplane wings 38, 38′ and stabilizers 39, 39′ conjoint to the fuselage portion, control surfaces including ailerons 51, 52, elevators 53, 54 and rudder 55 operatively attached to the wings, horizontal stabilizers and vertical stabilizer, respectively. A plurality of torque transmitting rods 64, 65, 66, 67, are fixedly joined with control surfaces 51, 52, 53, 55, respectively, torque transmitting rod 66 is also fixedly joined with control surface 54. A plurality of control levers 60, 61, 62, 63, are fixedly mounted on torque transmitting rods 64, 65, 66, 67 of control surfaces, respectively, for the purpose of transmitting control motion to control surfaces by control linkage means which is shown in FIGS. 4A, 5A and will be described later herein. A plurality of magnetic inter-modular structural connector members 56, 57, 58, 59 are distributed in fuselage portion 50 and affixed at selected locations. Inter-modular structural connection alignment structures 34, 35, 36, 37 are provided for assisting inter-modular structural connection by connection means which is shown in FIG. 3 and will be described in detail later in this document.

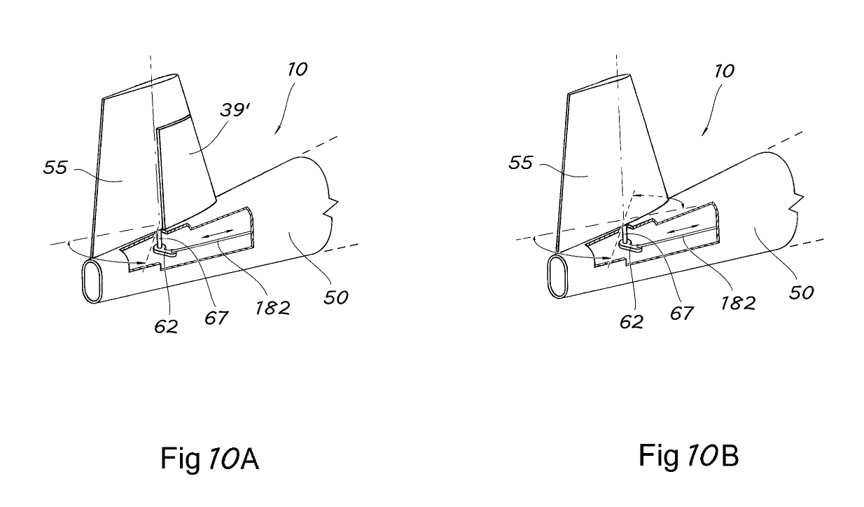

It is to be understood that the numbers, locations and configurations of wings, stabilizers, the number and types of control surfaces, whether associated and attached to a fin as shown in FIG. 10A or standalone unassociated to a fin as shown in FIG. 10B with same reference numerals as in FIG. 1, can vary according to the airplane design, and should not be limited by the embodiment herein presented; The arrows in FIG. 10A an FIG. 10B indicate the manners and extents of the movement of the control surfaces.

It is to be appreciated substantial airplane style characteristics and aerodynamic specifications can be incorporated into character module 10.

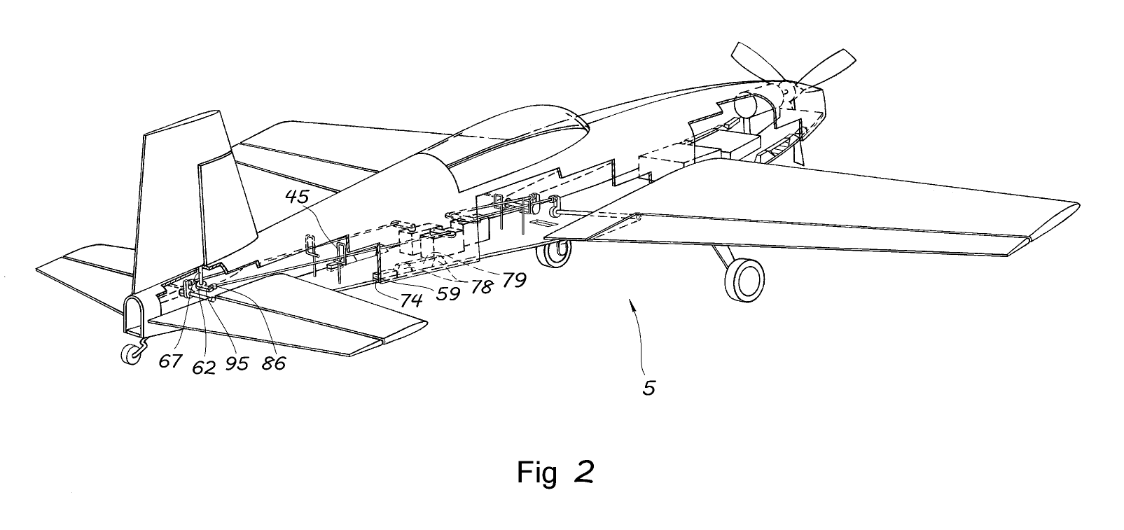

Component module 20 comprises a fuselage portion 88 complementing fuselage portion 10 to form a airplane fuselage, essential airplane components for airplane operations including a propulsion unit having engine 69 and propeller 68, electronics unit 70 for processing remote control and/or auto-piloting signals to control on-board components, power sources 71 to provide power for onboard power consuming components, actuating devices 40, 41, 42, to provide mechanical control motion for control surfaces rudder 55, elevators 53, 54, and ailerons 51, 52, respectively, and support structures adhered to fuselage portion 88 provided for attaching essential airplane components thereto. Said essential airplane components are mounted on said support structures. In current embodiment said support structures are incorporated into the fuselage portion 88, and therefore not explicitly shown. Operative interconnection of essential airplane components, as shown in FIG. 8, are implied, but not explicitly shown in FIGS. 1 and 2.

A plurality of inter-modular structural connectors 72, 73, 74, 75, magnetically attractive to the inter-modular structural connectors 56, 57, 58, 59 of character module 10, respectively, are distributed on fuselage portion 88 and affixed at locations opposite and properly connectable to inter-modular structural connector members 56, 57, 58, 59, respectively, forming magnetically attractive connector member pairs. Inter-modular structural interface alignment structures 76, 77, 78, 79 are provided on the component module opposite to complementary structures 34, 35, 36, 37 on the character module for assisting inter-modular structural connection by connection means which is shown in FIG. 3 and will be described in detail later herein.

A plurality of control motion transmission rods 80, 81, 82, 83, have one end operatively coupled to motion output levers 99, 99′, 97, 98 of servo devices 42, 40, 41, respectively. Cylindrically shaped and axially magnetized magnet elements 84, 85, 86, 87 are fixedly and coaxially attached to the free end of rods 80, 81, 82, 83, respectively, so that the free end surfaces of the magnets are perpendicular to the axes of the rods to which the magnets are attached. A plurality of control rod guide members 43, 44, 45, 46, attached to said support structure incorporated in the fuselage portion 88, each having an aperture through which the control motion transmission rods 80, 81, 82, 83 pass, respectively, provide both support and lateral movement limits for said control motion transmission rods. Optional landing gear 89, 90 are removably attached to the component module. Optional openings 91, 92 are provided on fuselage portion 88 for control coupling inspection and adjustment after module members are interconnected.

It is to be understood that the number and type of components onboard the component module should be sufficient for the types of airplane intended by the modular system, and not be limited to those embodied herein.

It is also to be understood that although not reflecting the advantages represented by this invention fins, with or without control surfaces, are not excluded by this invention in the component module embodiment.

It is to be appreciated that said support structures for attaching essential airplane components can take various forms, such as a frame mounted with essential components attached to fuselage portion 88, or fuselage portion 88 itself incorporating support structures for attaching said essential components. The specific structure, however, does not directly relate to the advantages of this invention.

The embodiment FIGs presented herein do not show interconnections among said essential components, however it is to be understood that an operatively interconnected electrical, control and power environment sufficient for normal functioning of components shown is implied. FIG. 8 illustrates operational interconnection of the essential airplane components in the form of a simplified schematic diagram.

In FIG. 3 the inter-modular structural connection means is shown in detail. It is to be understood that although said plurality of connector member pairs and said plurality of alignment structures collectively contribute to the inter-modular structural connection means it is sufficient to illustrate the operation using only one of the connector pairs 58, 75 and one section of the alignment structures 37, 79 of current embodiment.

The inter-modular structural connection means comprises a mutually magnetically attractive member pair 58, 75 oppositely affixed on opposing module members 10, 20 at predetermined locations for ensuring airplane structural and aerodynamic integrity when the module members are connected and held together by mutual magnetic attraction force. The magnetic attraction strength between members in said pair is selected to ensure the airplane's structural integrity under allowable operating conditions and also to enable nondestructive inter-modular structural disconnection under intentional or unintentional excessive structural tension situations.

An interlocking mechanism comprises physically matching structural members 37, 79 joined at or being an extension of opposing modules 10, 20, respectively. Structure member 79 forms a valley shaped opening wider at the top than at the bottom. The shape and size of structure member 37 substantially complements the valley shape and size of structure member 79. During the process of inter-modular structural connection modules 10 and 20 are brought to physical proximity where member 79 starts to accept member 37. The wider opening of the valley of member 79 provides relative position tolerance for the two approaching modules. The structure 79 provides guidance for the approach to interconnection. The matching shapes of members 37, 79 provide precise inter-modular structural connection alignment and inter-modular lateral interlocking once modules 10, 20, are structurally interconnected.

As the modules 10, 20 approach one another and reach the proximity of the range of sufficient attractive magnetic force between members 58 and 75 the subsequent inter-modular structural connection will proceed substantially automatically by the attractive magnetic force.

The magnetic attraction strength between the connector members 58 and 75 is chosen such that in the event of excessive inter-modular structural parting stress of intentional or unintentional cause, inter-modular structural disconnection will occur before the stress exceeds the maximum allowed structural stress for modules 10 and 20, resulting in nondestructive module-wise disconnection.

It is to be appreciated that the interlocking mechanism can be achieved with differing structure forms, and in cases where requirements on inter-modular structural alignment and lateral displacement are not stringent the interlocking mechanism may not be necessary.

There are four similar control linkages in current embodiment, coupling the rudder, elevator and two ailerons to the associated servo devices, respectively. A representative control linkage assembly according to current invention in current embodiment is illustrated in FIGS. 4A, 5A, and is sufficient to illustrate the principle.

It is to be understood that the purpose of FIG. 4A is to illustrate the operation principle of the control linkage means. Although the numerical notations of the linkage between rudder 55 and associated servo device 40 in FIGS. 1, 2 are used, the illustration in FIG. 4A is not intended to scale or to be graphically identical to any of the linkage assemblies shown in FIGS. 1, 2.

As shown in FIG. 4A, the control linkage means provides control motion linkage from a servo device 40 having motion lever 97 to a control surface member 55 via a control motion linkage assembly.

Said control motion linkage assembly comprises a rod member 82 with one end operatively coupled to servo lever 97, a linkage guide member 45 secured on component module 20 and having an aperture through which the rod member 82 passes, a cylindrically shaped magnet 86 attached coaxially to the free end of rod member. The aperture of the guide member 45 defines a limited spatial orientation region for the rod 82 while not restricting the control motion transmission movement of the rod.

Said control linkage assembly further comprises a control-motion-receiving lever 62 perpendicularly affixed to a torque rod 67 extended from the control surface 55, a magnetically attractive member 95 fixedly attached to the coupling end of lever 62 extending substantially perpendicular to both the lever body 62 and the torque rod 67 toward the servo lever 97. The exposed surface of member 95 is smooth and spherical in shape.

The relative angle between lever 62 and control surface 55 is chosen such that the control surface is at neutral position when controlling servo lever 97 is at its neutral position.

When the magnetic end surface of the magnet member 86 on the rod 82 connects to the magnetic attractive member 95 on the lever 62, shown as 86′ in dashed lines in FIG. 4A, the attractive magnetic force will maintain the contact so long as the linkage tension at the connection point does not exceed the magnetic attraction force. This connection means allows the lever 62 to pivot about the connecting point and therefore it allows control motion to be transmitted from the servo arm 97 through the rod 82 to the lever 62 which in turn moves the control surface, thus forming a control motion linkage. The magnetic attraction strength between the coupling members 86 and 95 is chosen to sustain the coupling linkage under allowed operation conditions.

With reference to FIG. 5A, the preferred embodiment of means for isolating the control surface from excessive pulling tension present in the control linkage is disclosed, based on the preferred control linkage embodiment shown in FIG. 4A. The lever 62 has an end portion 162 extending beyond coupling member 95 and forming a spatial relationship with coupling member 95, such that as the rod 82 is pulled in the direction away from lever 62 causing the angle between rod 82 and lever 62 to increase from the neutral position of about 90 degrees, at a certain angle the flat coupling surface of the coupling magnet 86 will be in contact with both the spherical surface of the coupling member 95 on lever 62 and the end portion 162 of the lever 62, as shown in FIG. 5A in the solid lined position, which will prevent further increase in angle without disconnecting member 86 from member 95 and therefore de-linking the control linkage. Continued pulling of the rod 82 along the same direction will cause decoupling of the linkage. This mechanism isolates and therefore protects the control surface and associated structures from excessive tension present in the control linkage.

The length of the motion transmitting rod 82 and the location of the guide member 45 are adjusted such that when modules 10 and 20 are structurally interconnected the magnetic coupling member 95 on lever 62 will be able to operatively couple with the coupling magnet member 86 on the rod 82 to form a control linkage.

The size and shape of the guide aperture is adjusted to limit the rod orientation to ensure the magnetic coupling members 95 and 86 stay within sufficiently close range of one another while not restricting control motion transmission, where magnetic attraction induced coupling will occur substantially automatically when the two modules are interconnected structurally.

The main advantage of the inter-modular structural connection and control linkage means of the current invention of the modularized airplane is that the processes for inter-modular connection and disconnection can be achieved by simply placing the modules together allowing magnetic auto-connection and simply pulling the modules apart from one another, and therefore it enables swift, effortless and substantially automatic inter-modular structural connections and control linkage couplings to form a functional airplane, as well as nondestructive module-wise disconnection under excessive structural and control linkage stress situations facilitating both rapid, substantially effortless module-wise disconnection of an airplane and heightened resistance to high impact damage.

With reference to FIG. 2, a modularized airplane having module members 10 and 20 as in FIG. 1 interconnected by inter-modular connection means and control linking means according to current invention is revealed.

Referring now to FIGS. 4B to 4G, a number of alternative embodiments of control linkage means are disclosed.

The first alternative embodiment is illustrated in FIG. 4B, in which the control surface member 55 has no torque rod attached, and the control motion receiving lever 62 is directly mounted on the control surface.

A variation of the embodiment revealed in FIG. 4B is illustrated in FIG. 4C, in which the control surface member 55 has no transmission lever, and the magnetically attractive coupler 95 is attached to a mounting structure 95′ provided on the control surface 55, linking the control surface to the control rod 82 substantially perpendicularly. The distance between the coupling member 95 and the operation axis 55′ of the control surface serves effectively as a lever.

An alternative of the preferred embodiment disclosed in FIG. 4A is disclosed in FIG. 4D, in which the magnetically attractive coupling member 95 is cylindrical in shape and coaxially secured on a base member 102 which in turn is pivotally coupled to the control motion receiving lever 62.

With reference to FIG. 4E, another alternative of the preferred embodiment shown in FIG. 4A is disclosed, in which the methods for linking the servo lever member 97 to the control surface lever 62 is the exact reverse of the linkage shown in FIG. 4A. An alternative embodiment for the means for isolating the control surface from excessive pulling tension, involving member 110, is shown which will be described in detail later herein. The main advantage of the alternative embodiment for the control linkage means shown in FIG. 4E is that it allows more dimensional freedom in designing the airplane style-characteristics-specific module member, denoted as character module 10 in current embodiment by varying the length of control link rod 182, now linked pivotally to control surface lever 62 by coupling end 102, as shown in FIG. 4E.

With reference to FIG. 4F, another alternative embodiment of the control linkage method is shown, in which the methods for linking the servo lever member 97 to the control surface lever 62 is the exact reverse of the linkage shown in FIG. 4D. An alternative embodiment for the means for isolating control surface from excessive pulling tension, involving member 110, is shown which will be described in detail later herein. This alternative embodiment has the same advantage as that described in the embodiment shown in FIG. 4E.

With reference to FIG. 4G, another alternative control linkage embodiment is disclosed, in which the control rod comprises two separate portions, 82 with coupling end 101 and 182 with coupling end 102, pivotally coupled to servo lever 97 and control surface lever 62, respectively. Two mutually magnetically attractive members 86, 103, cylindrical in shape, are coaxially attached at the free ends of the two control rod portions 82 and 182, respectively. Two guide members, 45 affixed on module 20 and 145 affixed on module 10, are provided to guide the two control rod portions 82 and 182, respectively. An alternative embodiment for the means for isolating the control surface from excessive pulling tension, involving member 110, is shown which will be described in detail later herein. This alternative embodiment has the same advantage as that described in the embodiment shown in FIG. 4E.

With reference to FIG. 4H, another alternative embodiment of the control linkage is shown, in which the linkage rotation about its longitudinal axis (“axial rotation” hereinafter) is utilized for transmitting control motion from the servo 40 to the control element 55.

The linkage comprises two portions, portion 82 having a coupling end 101 and portion 182 having a coupling end 102, rotatably coupled to motion output end 97 of servo 40 and control motion receiving end 62 of control element 55, respectively, both shown in the form of a universal joint for illustration, tolerating minor servo motion output to control surface motion input axial misalignment, two mutually magnetically attractive magnet members 86, 103, are oppositely attached at the free ends of the two linkage portions 82 and 182, respectively, facilitating separable longitudinal connection of the two linkage portions 82 and 182 by magnetic force to form one linkage, an axial rotation engagement device having a rotation coupling key member 87 extending transversely from the free end of the linkage portion 82 behind the magnet member 86, a longitudinally slotted socket member 104 having open-ended slot 105 coaxially affixed at the free end of linkage portion 182, housing the magnet member 103, adapted to coaxially receive, with clearance fit, the free end of the linkage portion 82 with attached magnet member 86 into the socket through the socket opening and the rotation coupling key member 87 into the socket slot 105 through the slot opening when the magnet members 86 and 103 at the free ends of the two linkage portions are connecting one another by attractive magnetic force, and to interlock the free ends of the linkage portions when the magnet members physically contact one another, engaging the linkage portions 82 and 182 for axial rotation. FIG. 4J shows a close-up view of the rotation engagement device in its disconnected state (a) with linear arrows showing the direction of linkage portions movement for connection, and the connected state (b) showing connected and interlocked linkage portions, with the circular arrows indicating linkage portions engaged for axial rotation.

A linkage-length-buffer device permitting certain degree of linkage portion length variation while not affecting the linkage axial rotation is incorporated in the linkage portion 82 to provide linkage length variation flexibility; For illustration purpose one possible embodiment for linkage portion 82 is shown in FIG. 4I, and a close-up view is illustrated in FIG. 4K in which the linkage portion 82 comprises two sub-portions, sub-portion 82′ having the magnet member 86 at its first end, and 82″ having the coupling end 101 as its first end and a coupling key element 201′ transversely extending from its second end, a slotted socket element 201 having a close-ended longitudinal slot 200 coaxially affixed to the second end of sub-portion 82′ and longitudinally accommodating, with clearance-fit through the socket opening, the second end of sub-portion 82″ into the socket space and the coupling key element 201′ into the slot 200 allowing relative linear longitudinal movement of sub-portion 82″ to sub-portion 82′ to the extent defined by the travel of the coupling key element 201′ in the slot 200, hence permitting length variation for linkage portion 82; FIG. 4K (a) and (b) illustrate the linkage length variation with the linear arrow showing the direction and extent of a longitudinal movement of the linkage sub-portion 82″ relative to 82′ within the limit of the slot 200, and the circular arrows show the axial rotational relationship between the two sub-portions is un-affected by the linkage-length-buffer; The close-ended slot 200 limits travel of the key element 201′, preventing linkage portion separation.

The linkage guide elements 45, 145 for limiting the transverse movement of the linkage portions, and the element 110 for isolating the control element 50 from excessive linkage tension are shown to function similarly as the similar elements in FIG. 4G.

For illustration purpose, a mechanical worm drive coupling is shown having a worm 202 and a meshing gear 202′ for converting the axial rotation of the linkage portion 182 to the motion of the control element 55.

With reference to FIG. 4I, another embodiment of the control linkage is disclosed, in which two independent control motions transmission, from servo 40 to control element 55 and servo 41 to control element 54, are carried out independently and simultaneously by the linkage axial rotation motion and the linear longitudinal motion.

The linkage comprises two portions, portion 82 having a coupling end 101 and portion 182 having a coupling end 102, rotatably coupled to motion output end 97 of servo 40 and control motion receiving end 62 of control element 55, respectively, both shown in the form of a universal joint for illustration, tolerating minor servo motion output to control surface motion input axial misalignment, two mutually magnetically attractive magnet members 86, 103, are oppositely attached at the free ends of the two linkage portions 82 and 182, respectively, facilitating separable longitudinal connection of the two linkage portions 82 and 182 by magnetic force to form one linkage, a rotation engagement device having a rotation coupling key member 87 extending transversely from the free end of the linkage portion 82 behind the affixed magnet member 86, a longitudinally slotted socket member 104 having open-ended slot 105 coaxially affixed at the free end of linkage portion 182, housing the magnet member 103, adapted to coaxially receive, with clearance fit, the free end of the linkage portion 82 with attached magnet member 86 into the socket through the socket opening and the rotation coupling key member 87 into the socket slot 105 through the slot opening when the magnet members 86 and 103 at the free ends of the two linkage portions are connecting one another by attractive magnetic force, and to interlock the free ends of the linkage portions when the magnet members physically contact one another, engaging the linkage portions 82 and 182 for axial rotation. FIG. 4J shows a close-up view of the rotation engagement device in its disconnected state (a) with linear arrows showing the direction of linkage portions movement for connection, and the connected state (b) showing connected and interlocked linkage portions, with the circular arrows indicating linkage portions engaged for axial rotation.

A linkage-length-buffer device permitting certain degree of linkage portion length variation while not affecting the linkage axial rotation is incorporated in the linkage portion 82 to provide linkage length variation flexibility; For illustration purpose one possible embodiment for linkage portion 82 is shown in FIG. 4I, and a close-up view is illustrated in FIG. 4K in which the linkage portion 82 comprises two sub-portions, sub-portion 82′ having the magnet member 86 at its first end, and 82″ having the coupling end 101 as its first end and a coupling key element 201′ transversely extending from its second end, a slotted socket element 201 having a close-ended longitudinal slot 200 coaxially affixed to the second end of sub-portion 82′ and longitudinally accommodating, with clearance-fit through the socket opening, the second end of sub-portion 82″ into the socket space and the coupling key element 201′ into the slot 200 allowing relative linear longitudinal movement of sub-portion 82″ to sub-portion 82′ to the extent defined by the travel of the coupling key element 201′ in the slot 200, hence permitting length variation for linkage portion 82; FIG. 4K (a) and (b) illustrate the linkage length variation with the linear arrow showing the direction and extent of a longitudinal movement of the linkage sub-portion 82″ relative to 82′ within the limit of the slot 200, and the circular arrows show the axial rotational relationship between the two sub-portions is un-affected by the linkage-length-buffer; The close-ended slot 200 limits travel of the key element 201′, preventing linkage portion separation.

An additional coupling point 98′ is provided to the sub-portion 82′ of linkage portion 82 for coupling to motion output end 98 of an additional servo 41; for illustration an embodiment of an axisymmetric linear gear and a meshing circular gear are shown as 98′ and 98, respectively.

The linkage portion 182 in FIG. 4I has similar structure as that of portion 82, having a linkage-length-buffer device involving slotted socket 202, longitudinal slot 203 and coupling key element 202′, permitting length variation for linkage portion 182; An additional coupling point 100 is provided to the sub-portion between the linkage-length-buffer device and the magnet element of linkage portion 182 for coupling to an additional control element 55 through its motion input 62.

Thus when the linkage portions of control linkage embodiment shown in FIG. 4I are connected and interlocked, the collective axial rotation of the linkage, and the independent longitudinal linear motion of the section of the same linkage between the two linkage-length-buffer devices can be utilized for two independent motion transmissions simultaneously.

The linkage guide elements 45, 145 for limiting the transverse movement of the linkage portions, and the element 110 for isolating the control element 50 from excessive linkage tension are shown to function similarly as the similar elements in FIG. 4G.

It is to be appreciated the specific choices of coupling method for FIG. 4A-4I, including coupling between the linkage portions, servos and control elements are for illustration purpose, and are not intended for proving unique and essential for the intended functions in the embodiments.

It is also to be appreciated linkage disclosures of this invention illustrated by FIG. 4A-4I are applicable to control motion transmission as well as other mechanical motion transmission applications, such as propulsion motion transmission.

The magnetic connections incorporated in the control linkage embodiment disclosures FIG. 4A-4I of the current invention facilitate substantially quick and effortless connection of the linkage portions in forming the integral linkage, as well as excessive linkage parting tension induced non-destructive linkage disconnection.

Referring now to FIGS. 5B to 5D, a number of alternative embodiment for the means for isolating the control surface from excessive pulling tension according to current invention are disclosed.

With reference to FIG. 5B, an embodiment variation of the means for isolating the control surface from excessive pulling tension shown in FIG. 5A is disclosed, the control linkage embodiment herein is based on that shown in FIG. 4C, in which the control surface 55 has no control lever, and the coupling member 95 is attached to a mounting structure 95′provided on the control surface 55 having a portion 162 extending beyond coupling member 95 in the direction away from the control surface operation axis 55′. The functional principle in this embodiment is identical to that disclosed in the embodiment shown in FIG. 5A.

With reference to FIG. 5C, an alternative embodiment of the means for isolating the control surface from excessive pulling tension present in the control linkage is disclosed, based on the control linkage embodiment disclosed in FIG. 4D. The lever 62 has an end portion 162 extending beyond the lever coupling point and forming a spatial relationship with coupling base member 102, such that as the rod 82 is pulled in the direction away from lever 62 causing the angle between rod 82 and lever 62 to increase from the neutral position of about 90 degrees, at a certain angle the coupling base member 102 will be in physical contact with the end portion 162 of the lever 62, as shown in FIG. 5C in the solid lined position, which will prevent further increase in angle without disconnecting member 86 from coupling base member 102 and therefore de-linking the control linkage. Continued pulling of the rod 82 along the same direction will cause decoupling of the linkage. This mechanism isolates and therefore protects the control surface and associated structures from excessive tension present in the control linkage.

With reference to FIG. 5D, an alternative embodiment of the means for isolating the control surface from excessive pulling tension present in the control linkage is disclosed, based on the control linkage portion from the control surface lever 62 to the member 103 in the embodiments disclosed in FIG. 4E to 4G. A rigid structure 110 is extended transversely from a predetermined location on rod 182, impassible through the aperture in guide 145, forming a spatial relationship with the guide member 145, such that as the rod 182 is pulled in the direction away from lever 62 causing the angle between rod 182 and lever 62 to increase from the neutral position of about 90 degrees, at a certain angle the rigid structure 110 will be in physical contact with the guide member 145, as shown in FIG. 5D in the solid lined position, which will prevent further increase in angle without disconnecting member 103 from the other linkage portion and therefore de-linking the control linkage. This mechanism isolates and therefore protects the control surface and associated structures from excessive tension present in the control linkage.

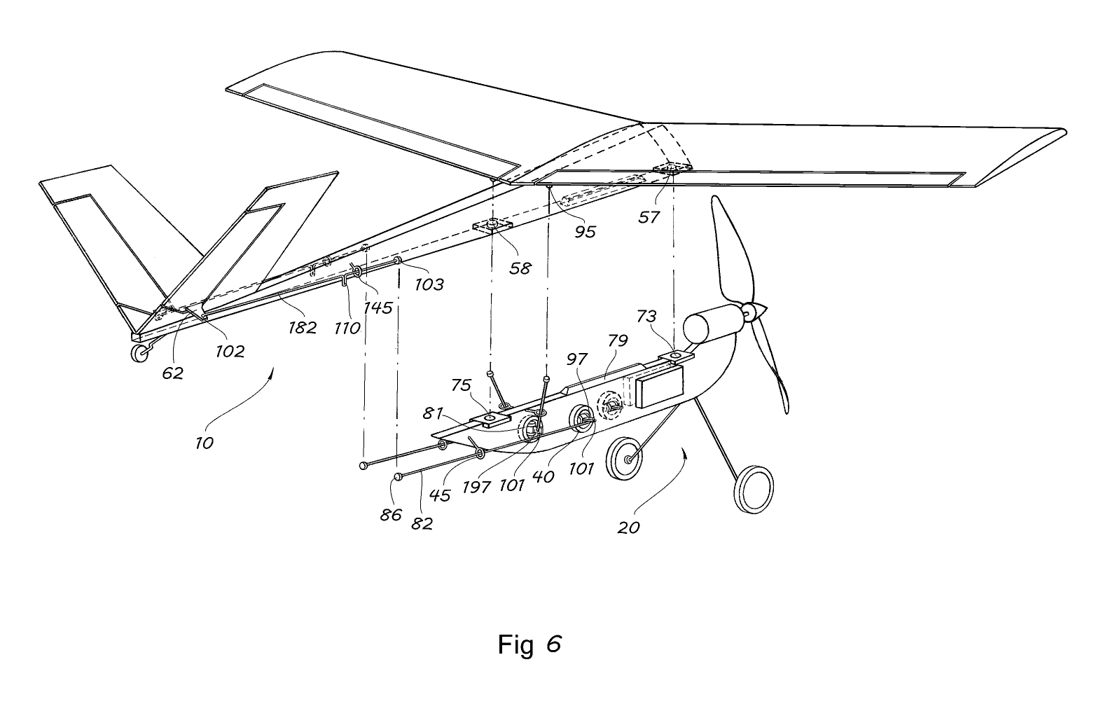

Referring now to FIG. 6, an alternative embodiment of the modularized airplane is disclosed, in which control linkages for the tail control surfaces and for the ailerons are based on the alternative embodiment revealed in FIG. 4G and 4C, respectively, the means for isolating the control surface from excessive pulling tension for the tail control surface linkages and for the aileron linkages are based on the alternative embodiment disclosed in FIG. 5D and FIG. 5B, respectively. This embodiment has the advantages of permitting variable length of the character module 10 and independently variable control surface longitudinal locations.

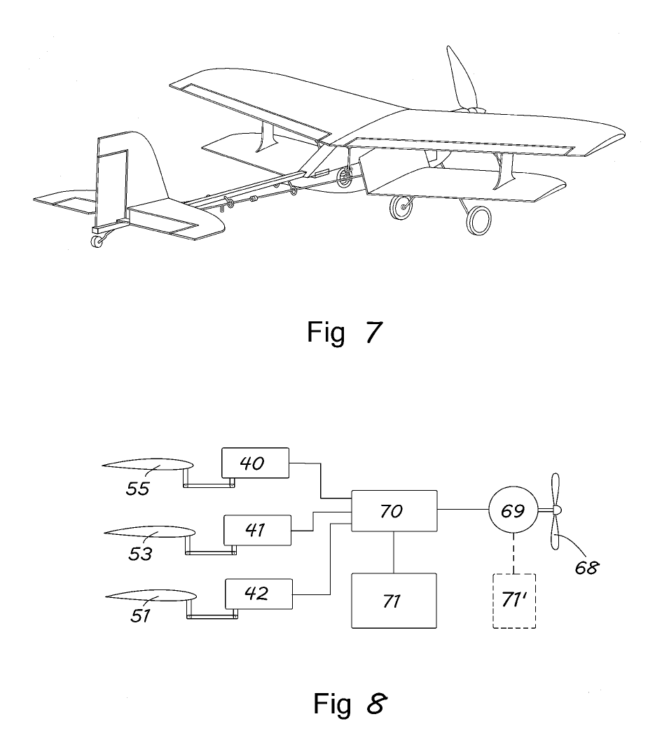

With reference to FIG. 7, a differing modularized airplane formed with the component module shown in FIG. 6 and a plane module different from the one shown in FIG. 6 is illustrated, which represents one aspect of the advantages represented by current invention.

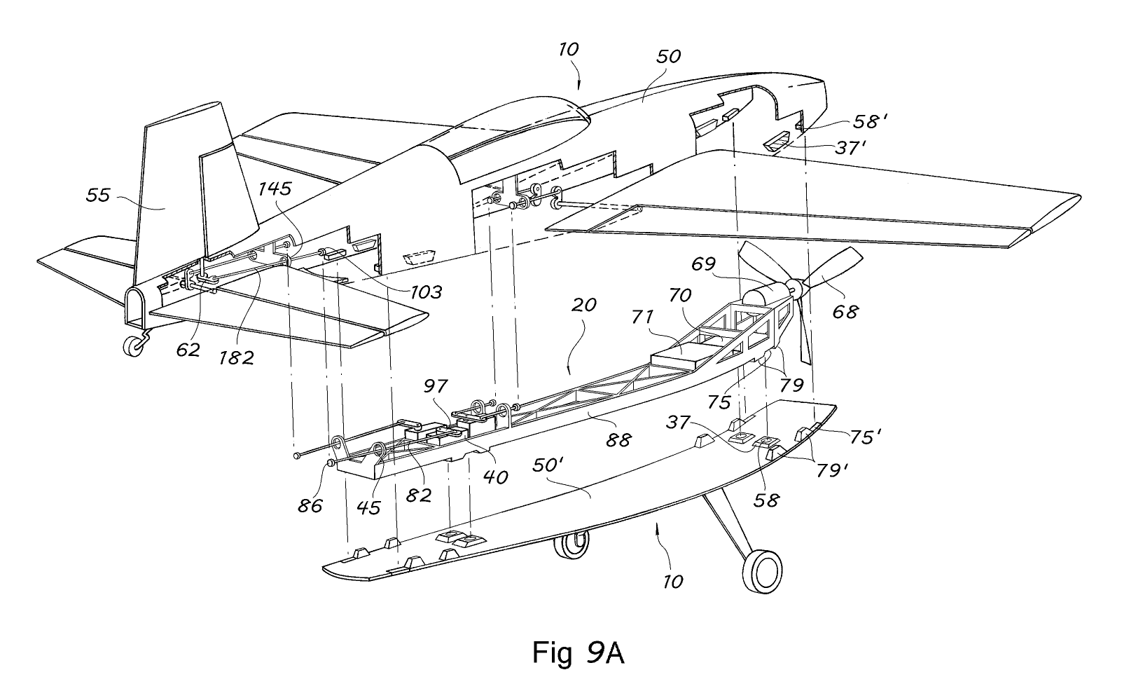

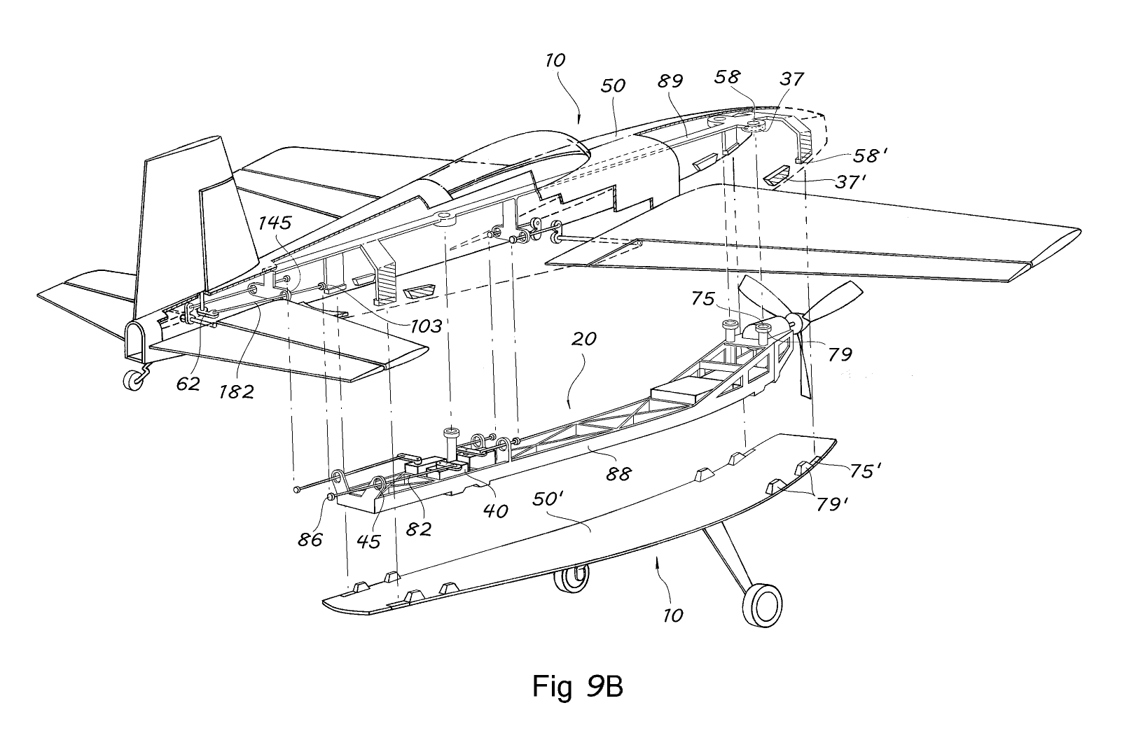

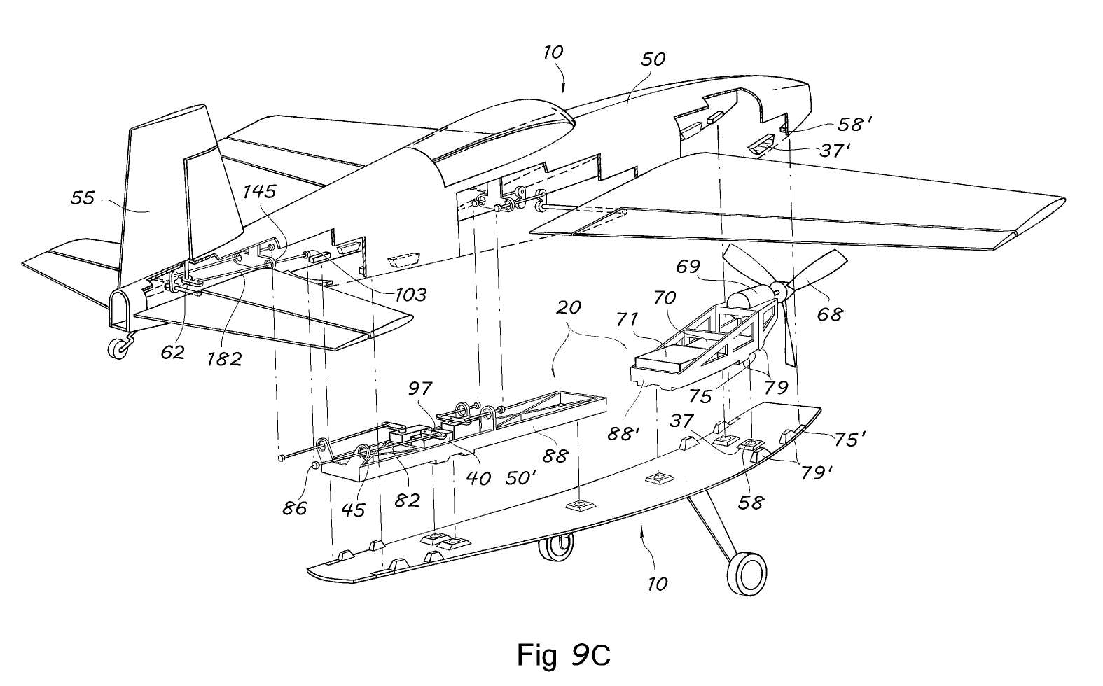

Referring now to FIG. 9A, an alternative embodiment of the modularized airplane is disclosed. In this embodiment the component module 20 comprises a flight components support structure 88 with flight components mounted thereon, and incorporated with control linkage guide structures; the fuselage of the character module 10 comprises separably connected complementary fuselage portions 50 and 50′ forming a fuselage internal space adapted to substantially accommodate the component module 20 and the structural and linkage wise connections between the two modules.

The component module 20 and the character module 10 are structurally connected to one another by the detachable structural connection method; The method of FIG. 3 is shown used in FIG. 9A for illustration, the typical magnetic connector pair 75, 58 and interlocking structures 79, 37 distributed on the component module 20 and the character module 10, respectively, are labeled for illustration. For the clarity of display, in this embodiment the component module 20 is shown connected to the fuselage portion 50′ of the character module, and positioned substantially inside of the fuselage inner space formed by the fuselage portions 50 and 50′. Alternatively by the same connection means the component module 20 can be connected to the fuselage portion 50.

The fuselage portions 50′ and 50 of the character module 10 are connected by detachable means; The detachable connection means of FIG. 3 is shown used in FIG. 9A for illustration, the typical magnetic connector pair 75′, 58′ and interlocking structures 79′, 37′ distributed on the fuselage portion 50′ and the other fuselage portion 50, respectively, are labeled for clarity of illustration

The flight components mounted on the component module include least one servo device 40, there can also be an electronics control device 70, a propulsion device having a motor 69 and a propeller 68, and a power source 71 to suffice airplane operation.

This embodiment of the modularized airplane employs the control linkage assembly embodiment disclosed in FIG. 4G to link the control surfaces of the character module 10 to their corresponding servo devices mounted on the component module 20. In FIG. 9 the control linkage assembly linking rudder 55 and servo 40 is labeled for the purpose of illustration. The first control linkage portion comprises a link rod 82 with one end pivotally coupled to control lever 97 of servo 40, and a magnetically attractive, cylindrical connector member 86, co-axially affixed at the opposite end of said link rod 82. The linkage-guide structure 45 provided on support structure 88 facilitates a lateral movement-range limit for said first linkage portion. The second control linkage portion includes a link rod 182 with one end pivotally coupled to control lever 62 of the rudder 55, and a cylindrical connector member 103 magnetically attractive to said connector member 86 of said first control linkage portion, co-axially affixed at the opposite end of said link rod 82. The linkage-guide structure 145 provided at said character module 10 facilitates a lateral movement range limit for said second linkage portion. When the modules 10 and 20 are structurally interconnected the magnetic coupling members 86 and 103 of the two linkages portions 95 on lever 62 will be in close enough vicinity to one another, facilitated by the guide members 45 and 145, for the mutual magnetic attractive force to connect the two linkage portions to form one linkage, substantially automatically.

The linkage guide structure 145 and rigid structure 110 provided on said second control linkage portion facilitate a longitudinal motion limit for said second control linkage portion to isolate said control element from excessive pulling tension in the control linkage assembly.

In comparison with the embodiment shown in FIG. 1 the embodiment illustrated in FIG. 9A allows greater freedoms in the plane module design due to the fact that the component module is free from fuselage portion, and both its positioning inside of the plane module fuselage and the second linkage portions can be determined according to the choice of individual airplane.

With reference to FIG. 9B, a variation of modular airplane embodiment of FIG. 9A is illustrated, in which the component module 20 is to separably connect to the fuselage 50 of character module 10, the linkage guides, and a plurality of connectors of the module 10 are collectively mounted on or incorporated to a common framework, as part of module 10, adapted to be affixed to the fuselage 50, facilitating module 10 and 20 structural and linkage wise separable connection as well as separable connection of fuselage portions 50 and 50′.

The detachable connection means of FIG. 3 is shown used in FIG. 9B for illustrating separable inter-modular structural connection and fuselage portions connection, and representative magnetic connector pairs 75, 58 and 75′, 58′ and the corresponding interlocking structures 79, 37 and 79′, 37′ are labeled respectively for illustration clarity.

A further variation of modular airplane embodiment of FIG. 9A is shown in FIG. 9C, in which the component module 20 comprises more than one separate component structures with flight components mounted thereon; The positioning of the component structures in a modular airplane can be optimized according to the particular airplane design and requirement, allow further flexibilities in the plane module design.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A separable motion transmission linkage comprising:
first linkage portion, substantially elongated, having a first coupling end and a second coupling end, said first coupling end operatively connectable to an actuating device;
second linkage portion, substantially elongated, having a first coupling end and a second coupling end, said first coupling end operatively connectable to a control element;
separable connection means for longitudinally connecting said second coupling end of said first linkage portion to said second coupling end of said second linkage portion, comprising a pair of mutually magnetically attractive members oppositely affixed at said second coupling end of said first linkage portion and said second coupling end of said second linkage portion, enabling said linkage portions to be longitudinally and separably connectable to one another by said attractive magnetic force to form one linkage for motion transmission from said actuating device to said control element;
the strength of said mutual magnetic attraction force sustaining the connection of said first linkage portion to said second linkage portion is sufficient for the linkage connection to withstand the linkage stress under allowed motion transmission operation conditions without disconnection and to disconnect said linkage portions when the linkage parting stress reaches a predetermined level.

2. The separable motion transmission linkage of claim 1, further comprises:
guide means for limiting transverse movement of second coupling end of each said linkage portion to a region in which said linkage portions are oriented substantially toward one another, while not obstructing linkage motion under allowed operation.

3. The separable motion transmission linkage of claim 2, wherein said limited transverse movement region for second coupling end of each said linkage portion formed by said guide means further defines a limited spatial region in which said mutually magnetically attractive members of said first and second linkage portions are sufficiently close to one another to experience sufficient mutual magnetic attraction to result in magnetic force induced connection, and to permit linkage motion under allowed motion transmission operation.

4. The separable motion transmission linkage of claim 2, wherein said guide means comprises:
a rigid member having a fixed positional relationship with said actuating device, having a through hole forming an aperture through which said first linkage portion extends;
a rigid member having a fixed positional relationship with said control element, having a through hole forming an aperture through which said second linkage portion extends;
the shapes and sizes of said apertures are adapted for said linkage portions to be oriented substantially toward one another, un-obstructive to linkage motion under allowed operation.

5. The separable motion transmission linkage of claim 3, wherein said guide means comprises:
a rigid member having a fixed positional relationship with said actuating device, having a through hole forming an aperture through which said first linkage portion extends;
a rigid member having a fixed positional relationship with said control element, having a through hole forming an aperture through which said second linkage portion extends;
the shapes and sizes of said apertures are adapted to define a limited spatial region in which said mutually magnetically attractive members of said first and second linkage portions are sufficiently close to one another to experience sufficient mutual magnetic attraction to result in magnetic force induced connection.

6. The separable motion transmission linkage of 1, further comprises means for preventing device coupled to the linkage from being damaged by excessive linkage tension having:
first structure, rigid, in fixed positional relationship with said device coupled to the linkage;
second structure, rigid, provided at or extending from a predetermined location on the linkage portion said device is coupled to, in physical relationship with said first structure forming a longitudinal movement limit for said linkage portion hence forming a limited operating range for said device;
whereby, upon reaching said longitudinal movement limit said first structure is in physical contact with said second structure, preventing said linkage portion from further longitudinal movement, and further longitudinal movement will cause linkage parting stress to reaches said predetermined level, resulting linkage disconnection into said first linkage portion and second linkage portions.

7. The separable motion transmission linkage of claim 1, further comprises rotation engagement means for engaging said first and second linkage portions for axial rotation about the linkage axis defined by said first coupling ends of said first and second linkage portions when the linkage portions are connected by said magnetic force, comprising two physically matching and interlocking elements provided oppositely at the second coupling ends of said first and second linkage portions respectively, adapted to be un-obstructive to the connection of said linkage portions by said magnetically attractive members and to interlock with one another when said linkage portions are connected, thus engaging said linkage portions for axial rotation.

8. The separable motion transmission linkage of claim 7, wherein at least one of said linkage portions has the section between the coupling end of said first end and the magnet member of said second end formed with two elongated sections connected by a linkage-length-variation buffer device comprising two elements provided oppositely to one end of said two sections having structures adapted to coaxially couple one another permitting substantial free relative longitudinal movement between said two sections to a predetermined finite extent while preventing relative transverse and axial rotational movements between the two sections, thus allowing said linkage portion length variation to said finite extent.

9. The separable motion transmission linkage of claim 8, wherein
both said first and second linkage portions are formed by means defined therein, allowing linkage length variation to a predetermined finite extent;
a first additional coupling point is provided at a predetermined location on the section of said first linkage portion between said magnet member and said linkage-length-variation buffer device, operatively connectable to a second actuating device;
second additional coupling point is provided at a predetermined location on the section of said second linkage portion between said magnet member and said linkage-length-variation buffer device, operatively connectable to a second control element;
when said first and second linkage portions are connected the section between two said linkage-length-variation buffer devices is freely movable longitudinally relative to the rest of the linkage to a finite extent limited by that of said linkage-length-variation buffers, un-obstructive to the motion transmission by linkage axial rotation between the first coupling ends of said first and second linkage portion, thus permitting independent and simultaneous motion transmissions by linkage linear longitudinal motion between said first and second additional coupling points and by linkage axial rotational motion between the first coupling ends of said first and second linkage portion.

10. The separable motion transmission linkage of claim 9, wherein
the operative connections coupling said actuating device and control element to said linkage allow motion transmission by linkage axial rotational motion;
the operative connections coupling said second actuating device and second control element to said linkage section allow motion transmission by linkage section linear longitudinal motion.

11. The separable motion transmission linkage of claim 7, further comprises:
guide means for limiting transverse movement of second coupling end of each said linkage portion to a region in which said linkage portions are oriented substantially toward one another, not obstructing linkage motion under allowed operation.

12. The separable motion transmission linkage of claim 11, wherein said guide means comprises:
a rigid member having a fixed positional relationship with said actuating device, having a through hole forming an aperture through which said first linkage portion extends;
a rigid member having a fixed positional relationship with said control element, having a through hole forming an aperture through which said second linkage portion extends;
the shapes and sizes of said apertures are adapted for said linkage portions to be oriented substantially toward one another, un-obstructive to linkage motion under allowed operation.

13. A combination comprising:
(a) a modularized airplane having two modules,
a first module having a fuselage and a control surface movably attached to said fuselage or to a fin fixedly joined with said fuselage;
a second module having operatively interconnected airplane flight components for airplane operation including a servo device, a flight components support structure with said flight components mounted thereon;
(b) a separable motion transmission linkage of claim 1 for linking and transmitting control motions from said servo device to said control surface;
(c) a separable connection means for structurally connecting said first module and said second module, and for disassembling the airplane into separate said first module and said second module.

14. The combination of claim 13, wherein
said fuselage of said first module of the modularized airplane (a) comprises two portions, connectable to one another by a separable connection means, forming fuselage internal space adapted to substantially accommodate said second module and to connect said first and second modules by said linkage means (b) and connection means (c); said second module accesses said internal fuselage through a fuselage opening formed when said two fuselage portions are disconnected and apart.

15. The combination of claim 14, wherein
said separable connection means (c) comprises
at least one pair of connectors or connecting structures separably connectable to one another, provided to be oppositely affixed to said first module and said second module at predetermined locations, facilitating inter-modular structural connection and disconnection;
said separable connection means for connecting said two fuselage portions comprises at least one pair of connectors or connecting structures separably connectable to one another, provided to be oppositely affixed to said two fuselage portions at predetermined locations, facilitating fuselage portions connection and disconnection;
said linkage means (b) further comprises guide means for limiting transverse movement of second coupling end of each said linkage portion to a region in which said linkage portions are oriented substantially toward one another, while not obstructing linkage motion under allowed operation;

16. The combination of claim 15, wherein
at least one pair of connectors or connecting structures of said separable connection means (c) are mutually magnetic attractive to one another, and connectable by attractive magnetic force with strength sufficient for the connection to withstand the stress under allowed airplane operation conditions without disconnection and to disconnect when the parting stress between connected said first and second module reaches a predetermined level.

17. The combination of claim 16, wherein
at least one pair of connectors or connecting structures of said separable connection means for connecting said two fuselage portions are mutually magnetic attractive to one another, and
connectable by attractive magnetic force with strength sufficient for the connection to withstand the stress under allowed airplane operation conditions without disconnection and to disconnect when the parting stress between connected fuselage portions reaches a predetermined level.

18. The combination of claim 15, wherein
said first module of the modularized airplane (a) further comprises
a support structure adapted to be positioned and attached to one of said fuselage portions, having at least one connector or connecting structure of a said connector or connecting structure pair of the separable connection means (c) affixed thereto at said predetermined location opposite to its pairing connector or connecting structure affixed to said second module, facilitating inter-modular structural connection and disconnection, and incorporated with said guide means at predetermined location for said second linkage portion coupled to said control surface;
said second module is incorporated with said guide means at predetermined location for said first linkage portion coupled to said servo device.

19. The combination of claim 18, wherein
at least one pair of connectors or connecting structures of said separable connection means (c) are mutually magnetic attractive to one another, and connectable by attractive magnetic force with strength sufficient for the connection to withstand the stress under allowed airplane operation conditions without disconnection and to disconnect when the parting stress between connected said first and second module reaches a predetermined level;
said support structure of first module has at least one connector or connecting structure of a said connector or connecting structure pair of said separable connection means (c) affixed thereto at said predetermined location opposite to its pairing connector or connecting structure affixed to opposing position on said second module, facilitating structural connection and disconnection of said first and second modules;
said guide means comprises:
a rigid member having a fixed positional relationship with said servo device, having a through hole forming an aperture through which said first linkage portion extends, incorporated to said second module;
a rigid member having a fixed positional relationship with said control surface, having a through hole forming an aperture through which said second linkage portion extends, incorporated to said support structure of said first module;
the shapes and sizes of said apertures are adapted for said linkage portions to be oriented substantially toward one another, un-obstructive to linkage motion under allowed operation.

20. The combination of claim 19, wherein
at least one pair of connectors or connecting structures of said separable connection means for connecting said two fuselage portions are mutually magnetic attractive to one another, and connectable by attractive magnetic force with strength sufficient for the connection to withstand the stress under allowed airplane operation conditions without disconnection and to disconnect when the parting stress between connected fuselage portions reaches a predetermined level;
said support structure of first module has at least one connector or connecting structure of a said connector or connecting structure pair of said separable connection means for connecting said two fuselage portions affixed thereto at said predetermined location opposite to its pairing connector or connecting structure affixed to opposing fuselage portion, facilitating connection and disconnection of two fuselage portions.
